(19) United States
(12) Patent Application Publication
(10) Pub. No.: US 2025/0172606 A1
(43) Pub. Date: May 29, 2025

(54) DETERMINATION OF THE TEMPERATURE DEPENDENCY OF A FORWARD RESISTANCE

(71) Applicant: ZF Friedrichshafen AG, Friedrichshafen (DE)

(72) Inventors: Fabian Gross, Korntal-Münchingen (DE); Sebastian Besold, Neudrossenfeld (DE); Nóra Judit Mészáros, Budakeszi (HU); Johannes Hager, Marktleugast (DE)

(73) Assignee: ZF Friedrichshafen AG, Friedrichshafen (DE)

(21) Appl. No.: 18/960,562

(22) Filed: Nov. 26, 2024

(30) Foreign Application Priority Data
Nov. 27, 2023 (DE) 10 2023 211 768.1

(51) Int. Cl. G01R 31/26; B60R 16/023; G01R 27/14; G01R 31/27; H02M 1/00

(52) U.S. Cl. CPC G01R 31/2628; B60R 16/023; G01R 27/14; G01R 31/2601; G01R 31/275; H02M 1/0048

(57) ABSTRACT

A device for determining temperature dependency of a forward resistance in a switch in a power semiconductor module, includes a pulse unit for sending a current pulse to the switch, a measurement unit for measuring the resistance in the switch during a measurement period while and/or after the current pulse has been sent to the switch, and an evaluation unit for determining a resistance/temperature curve for the switch based on the measured resistance and a predefined prediction model.

### CROSS-REFERENCE TO RELATED APPLICATION

This application claims priority to German Patent Application No. 10 2023 211 768.1, filed on Nov. 27, 2023, the entirety of which is hereby fully incorporated by reference herein.

### TECHNICAL FIELD

The present disclosure relates to a device for determining the temperature dependency of forward resistance in a power semiconductor module. The present disclosure also relates to a training apparatus for creating a prediction model, as well as a traction inverter for a vehicle, a method for determining a forward resistance temperature dependency for a power semiconductor module, and a computer program.

### BACKGROUND

Power electronics in electric and hybrid vehicles conduct electricity from a battery to an electric motor, converting direct current into alternating current. An AC inverter or traction inverter is used for this. Numerous transistors or other power semiconductors are normally used for this, which can be combined to obtain a power semiconductor module, and are switched in short, regular intervals. In particular, MOSFETs (metal-oxide-semiconductor field effect transistors) and IGBTs (insulated-gate bipolar transistors) are used as switches for this. In the conducting state, the battery current is conducted to the motor (conducting phase). A voltage curve for the AC voltage is obtained through this high frequency switching process, which can then be used to power the traction motor. To increase the ampacity, numerous power semiconductors are usually connected in parallel in a (topological) switch.

Comparatively high currents are conducted through these power semiconductor modules, or power semiconductors, in this or other fields, generating high temperatures in the power semiconductors. Active cooling systems are frequently used to diminish switching and conducting losses. Malfunctions caused by material defects or control problems can result in excessive temperatures, which may cause the components in question to break down, or result in the module burning out. The power semiconductors have a maximum operating temperature (e.g. 150° C. for Si IGBTs, 175° C. for SiC MOSFETs). This maximum operating temperature is set by the semiconductor manufacturer. When configuring the power electronics drives, it must be ensured that this temperature is never exceeded in any operating state.

To be able to monitor the state, and identify defects and avoid dangerous situations, power semiconductor modules with integrated means for measuring the temperature have been developed. In the prior art, a negative temperature coefficient thermistor (NTC thermistor) or positive temperature coefficient thermistor (PTC thermistor) is used to monitor the chip temperature. The temperature can be measured on the basis of the temperature dependency of the resistance, such that the temperature in the power semiconductor module can be determined. There are also approaches in which temperature-sensitive electrical parameters (TSEPs) are used to enable a direct measurement of the power semiconductor temperature.

One challenge with the use of additional components for measuring the temperature in a power semiconductor module, or power semiconductor, is the extra space that is needed. Furthermore, the additional components must be spatially separated from the actual power semiconductor. This means that the temperature measurement does not take place at the relevant position. Consequently, the actual temperature of the power semiconductor must be calculated or estimated on the basis of this measurement.

In this context, a power module for an electric vehicle drive with an improved temperature determination for the power semiconductors is disclosed in DE 10 2020 208 167 A1. The power module contains numerous power switches, each of which contains a power semiconductor. The power module also contains control electronics for the numerous switches with which an output current is generated from an input current. The control electronics also contain a temperature unit that receives an operating voltage and operating current for the power semiconductors, based on which the temperature of the power semiconductor can be determined.

One challenge in measuring the temperature of a power semiconductor through its temperature-dependent forward resistance is the necessary calibration. A resistance/temperature curve is needed for this, because different materials or contacts, etc. may result in each power semiconductor, or power semiconductor module, having different characteristics in this regard. Fluctuations in this resistance/temperature curve as a result of different production processes thus require calibration for each power semiconductor or switch in order to determine this curve and obtain reliable temperature measurements. This calibration is complicated and relatively expensive, because it requires a relatively complicated heating of the power semiconductor module during the production thereof, while measuring the resistance and the temperature at the same time. This curve can also change over time when the power semiconductor module is used in a traction inverter for a vehicle, e.g. due to aging. Recalibration would then be needed to continue to be able to reliably measure the temperature.

### SUMMARY

Based on this, an object of the present disclosure is to create a method for determining the temperature dependency of a forward resistance for a switch in a power semiconductor module. In particular, the calibration should be less difficult, while still resulting in reliable data acquisition. An efficient method should be obtained. Moreover, it should be possible to obtain a reliable temperature measurement over the entire service life of the power semiconductor module or a traction inverter in a vehicle.

To solve this problem, one aspect of the present disclosure relates to a device for determining the temperature dependency of forward resistance for a switch in a power semiconductor module, which contains:
a pulse unit that sends current pulses to the switch;
a measurement unit for measuring the resistance of the switch in a measurement period during and/or after the switch has received the current pulse; and
an evaluation unit for determining a resistance/temperature curve for the switch based on the measured resistance and a predefined prediction model.

Another aspect of the present disclosure relates to a traction inverter in a vehicle that contains a power semiconductor module and a device like that described above, in which:
the measurement unit is designed to measure the resistance of the switch; and
the evaluation unit is designed to determine the temperature of the switch based on the resistance/temperature curve.

Another aspect of the present disclosure relates to a training apparatus for obtaining a prediction model, which contains:
an input interface for receiving numerous resistance/temperature curves for different switches; and
a modeling unit for creating the prediction model based on the resistance/temperature curves that are received, in which the modeling unit is designed in particular for training an artificial neural network.

Further aspects of the present disclosure relate to a method for the device and the training apparatus, and a computer program that executes the steps of the method on a computer. Other aspects of the present disclosure relate to memories on which computer programs are stored, with which the methods described herein can be executed on a computer.

Preferred embodiments of the present disclosure are described herein. It is understood that the features specified above and described below can be used not only in the given combinations, but also in and of themselves or in other combinations, without abandoning the scope of the present disclosure. In particular, the device, traction inverter, training apparatus, method, and computer program can be designed in accordance with the embodiments of the device described in the dependent claims.

With the device, a switch in a power semiconductor module receives a current pulse. A current pulse is thus conducted through the switch, causing it to heat up. This heating is preferably (well) below a maximum possible or acceptable temperature. The switch contains one or more power semiconductors. During and/or after conducting the current pulse, the resistance of the switch is measured. Based on this measurement, a resistance/temperature curve is determined for the switch using a predefined prediction model. The resistance/temperature curve assigns different resistances to each temperature. The temperature is not measured directly with the present disclosure, but instead is determined on the basis of a predefined prediction model. This prediction model contains data regarding the thermal behavior of comparable components. The prediction model therefore allows for a type of extrapolation based on the assumption that findings regarding the thermal behavior over the entire temperature range can be obtained with a current pulse that does not result in reaching a maximum possible temperature. Assuming that there is a clear scattering in the resistance/temperature behavior of individual switches, or power semiconductors, it is possible to draw a conclusion regarding the resistance/temperature curve through the use of a current pulse and by measuring the resistance in a measurement period. This curve can then be used for measuring the temperature (while in use) during further operation.

Compared to previous approaches for the calibration of a temperature determination for a power semiconductor without temperature sensors, in which heating to a predefined temperature takes place, the approach used with the present disclosure saves time and reduces costs. There is no need for an external temperature sensor for the calibration. It is possible to determine the resistance/temperature curve for a power semiconductor without relying on a direct temperature measurement, or without determining such entirely through taking measurements during calibration. Through the use of a predefined prediction model, it is possible to draw conclusions regarding the thermal behavior with which sufficiently precise operation can be obtained. This results in an efficient and precise method of calibration. This approach also allows for subsequent recalibration, e.g. when the power semiconductor module is already installed in a traction inverter for a vehicle. It is therefore possible to redetermine a resistance/temperature curve when in use, to plot possible changes in the resistance/temperature curve caused by aging, etc. This results in an improved and more accurate temperature measurement.

A training apparatus can be used to obtain the predefined prediction model. This training apparatus compiles numerous resistance/temperature curves for various switches, which are acquired in a conventional measurement process using temperatures sensors, for example, and then creates a corresponding prediction model based on the training data. In particular, an artificial neural network can be used and trained for this. Training data are therefore used in which resistance measurements are plotted in a measurement period to obtain the resulting resistance/temperature curves for different switches. The pretrained or predefined prediction model can then be used in the device obtained with the present disclosure.

The resistance/temperature curve obtained with the device can be used in a traction inverter for a vehicle. The temperature can then be determined therein to obtain the temperature of the power semiconductor or power semiconductor module. The power semiconductor itself can advantageously contain all of the components of the device obtained with the present disclosure. This means that no extra components are needed for the calibration, such that it is possible to calibrate, or recalibrate, during operation.

In a preferred embodiment, the pulse unit is designed to send a current pulse to the switch of 0.5 to 20 seconds, preferably 1 to 10 seconds, particularly preferably 1 to 2 seconds, with an amperage of 50 Å to 500 Å, preferably 100 Å to 250 Å, particularly preferably 150 Å to 200 Å. By using shorter current pulses, a sufficient heating and sufficient change in the forward resistance is obtained for drawing a reliable conclusion regarding the resistance/temperature curve if a corresponding predefined prediction model is available. This results in an efficient method of calibration.

In a preferred embodiment, the measurement unit is designed to measure the resistance based on a voltage measurement during the current pulse sent to the switch. The measurement unit can also be designed to measure the resistance based on a voltage measurement of a measurement current after sending the current pulse to the switch. The voltage measurement can therefore be based directly on the current in the current pulse, and voltage can be sampled during the current pulse. This voltage changes, even when the amperage remains constant, because the resistance changes during the heating caused by the current pulse. Because the current and the measurement period are known, the change in the resistance can be plotted and then used to determine the resistance/temperature curve with the predefined prediction model. A (small) measurement current can also be applied during the cooling phase, i.e. after the switch has received the current pulse, and the change in resistance can be determined on the basis thereof. During the cooling, after the current pulse has ended, the resistance also changes, because of the drop in temperature. These corresponding changes in temperature and resistance can also be used as the basis for determining the resistance/temperature curve. The measurements taken during the heating and cooling phases can be used. It is also possible to only take measurements during the heating or cooling phases. This results in an efficient manner of determining the resistance/temperature curve for a switch.

In a preferred embodiment, the evaluation unit is designed to determine the resistance/temperature curve through machine learning. In particular, a pretrained model can be used. The evaluation unit can also be designed to determine the resistance/temperature curve using a pretrained artificial neural network. The use of machine learning and an artificial neural network results in a reliable and precise prediction of a resistance/temperature curve when only one resistance is measured during a measurement period. It is therefore possible to predict an entire resistance/temperature curve from the change in resistance during the heating or cooling of the switch. The use of machine learning and artificial neural networks is an efficient method of implementation.

In a preferred embodiment, the pulse unit is designed to send a current pulse to a switch containing numerous power semiconductors. In particular, numerous power semiconductors can be connected in parallel to obtain a topological switch, which are then subjected to the same current pulse. The resistance of all of the power semiconductors connected in parallel is then measured. This results in an estimation of a maximum temperature. The resistance/temperature curve is obtained for all of the power semiconductors connected in parallel in a switch. This results in an efficient measurement or efficient determination of the temperature dependency of the forward resistance for the switch.

In a preferred embodiment, the device contains an input interface for receiving a calibration command. The pulse unit is designed to send a current pulse to the switch after receiving the calibration command. The measurement unit is designed to measure the resistance after receiving the calibration command. The evaluation unit is designed to determine the resistance/temperature curve after receiving the calibration command. The calibration command can be a signal that triggers a calibration process or recalibration. Consequently, changes in the resistance/temperature curve in the switch due to aging, for example, can be accounted for. If the resistance/temperature curve changes, a calibration command can be issued, or received, resulting in a renewed determination of the resistance/temperature curve based on the current state of the switch.

In a preferred embodiment, the input interface is designed to receive the calibration command from a vehicle control unit through a wireless connection, and/or after the occurrence of a predefined operating condition. The calibration command can be stored in a vehicle control unit and issued periodically, or when specific conditions occur, to initiate recalibration. The calibration command can also be triggered by a signal received through a wireless connection. Consequently, recalibration can be initiated externally. This results in a precise temperature measurement in a traction inverter over the lifetime of a vehicle.

In this context, a power semiconductor module is understood in particular to be an assembly for use in an inverter structure, or traction inverter, in a vehicle. A switch contains one or more power semiconductors. A power semiconductor module thus contains numerous power semiconductors or switches. A power semiconductor is an electronic chip that has one or more integrated switch components. By way of example, MOSFETs and/or IGBTs can be used. A current pulse is preferably a current of a constant amperage over a predefined (short) period of time that flows through the switch. The current therefore flows through one or more power semiconductors. The forward resistance, or resistance, is measured. A predefined prediction model can be understood to be a plotting rule that plots input values, i.e. measured resistances to obtain an output, i.e. a resistance/temperature curve. In particular, a predefined prediction model can be a pretrained artificial neural network. A resistance/temperature curve plots a (measured) resistance in relation to a temperature. A resistance measurement takes place in particular over a predefined time period.

The present disclosure shall be explained below in greater detail based on selected exemplary embodiments in reference to the drawings.

### BRIEF DESCRIPTION OF THE DRAWINGS

FIG. 1 shows a schematic illustration of a vehicle that has a traction inverter in accordance with various embodiments;

FIG. 2 shows a schematic illustration of a device in accordance with various embodiments for determining a forward resistance temperature dependency;

FIG. 3 shows a schematic illustration of a training apparatus in accordance with various embodiments;

FIG. 4 shows an exemplary qualitative illustration of various

resistance/temperature curves for different switches;

FIG. 5 shows a schematic illustration of the current curve over time for an exemplary current pulse;

FIG. 6 shows a schematic illustration of an exemplary resistance curved for the switch in a measurement time period; and

FIG. 7 shows a schematic illustration of a method in accordance with various embodiments.

### DETAILED DESCRIPTION

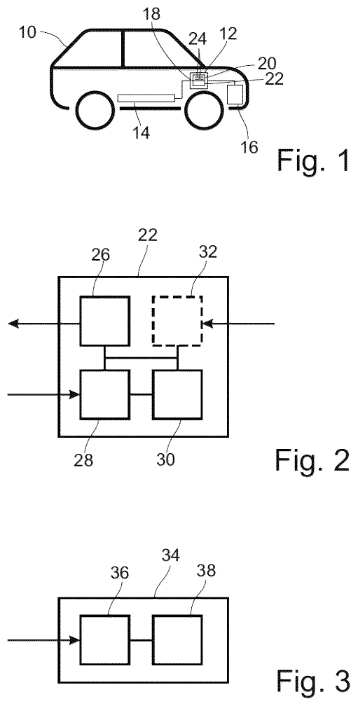

FIG. 1 shows a schematic illustration of a vehicle 10 that contains a traction inverter 12. The traction inverter 12 is between a battery 14 and an electric machine 16 in the vehicle 10, which converts the direct current from the battery 14 into the alternating current needed by the electric machine 16. The traction inverter 12 contains a power semiconductor 18 that has a switch 20 and a device 22 for determining the forward resistance temperature dependency in the switch 20. The illustration in FIG. 1 is a schematic sectional side view. The device 22 is integrated in the power semiconductor module 18, or part of the power semiconductor module 18, in this exemplary embodiment. In particular, it is possible to integrate the device 22 in a microprocessor in the power semiconductor module 18, or in the control electronics for the power semiconductor module 18. In other embodiments of the present disclosure, the device 22 can also be a separate component. There is also a switch 20 with two parallel power semiconductors 24 in this exemplary embodiment. In other embodiments it is conceivable for a switch 20 to contain just one power semiconductor 24, or to contain numerous power semiconductors 24.

The device 22 can be used to determine a temperature dependency for the resistance of the switch 20. Once this temperature dependency is known, the temperature of the switch 20, or power semiconductor module 18, can be determined by measuring the resistance. This measurement, or determination, of the temperature in a power semiconductor 24 is relevant for the safe operation of inverters or traction inverters. If a power semiconductor overheats, the inverter must reduce the output to prevent a malfunctioning. By measuring the temperature, it is possible to operate the inverter closer to its limit. Consequently, the output can be increased, or smaller power semiconductors can be used to reduce costs. The approach used with the present disclosure for determining the temperature of a power semiconductor 24 by use of its forward resistance temperature dependency is an indirect method of measuring the temperature. When in use, the voltage of the power semiconductor 24, which is a function of the current, is measured in the conducting state. The resistance can then be determined on the basis of this measurement. This resistance can be assigned to a temperature in a known resistance/temperature curve. The device 22 obtained with the present disclosure is used to determine this resistance/temperature curve. Fluctuations in the resistance/temperature curve caused by conditions during the production process have previously required this curve to be determined through calibration for each power semiconductor. With the present disclosure, this comparatively difficult calibration is no longer necessary. The fact that the resistance of a switch 20, or power semiconductor 24 changes in a characteristic manner when subjected to a current pulse is exploited for this. This resistance/time curve basically contains the characteristic of the resistance/temperature curve for the component that is examined or measured.

The device 22, in accordance with various embodiments, is shown schematically in FIG. 2. The device 22 contains a pulse unit 26, a measurement unit 28, and an evaluation unit 30. The device 22 can also contain in input interface 32. The various interfaces and units can be implemented, partially or entirely, with hardware and/or software. In particular, the device 22 can be a microcontroller or software for a microcontroller. This microcontroller can form a processor for a power semiconductor module 18, or the software can be software for this processor. The functioning of the present disclosure can be independent of whether or not the power semiconductor 18 is already installed in a traction inverter 12 in a vehicle. The approach used in the present disclosure can be executed directly after the production of the power semiconductor module 18 and during use after installation.

A current pulse is sent from the pulse unit 26 to the switch 20. This applies a current pulse. The current pulse can be generated in or sent from the pulse unit 26. The pulse unit 26 can thus be simply a switch 20, or a function with which a current is activated. By way of example, a current pulse can be output that lasts between 0.5 and 20 seconds, with an amperage of 50 Å to 500 Å. In particular, the current pulse can have a constant amperage. The current pulse can be applied to a single power semiconductor 24 or a switch with numerous power semiconductors 24. Numerous power semiconductors 24 are normally connected in parallel to form a (topological) switch. The temperature measurement then indicates the temperature of this switch 20.

The measurement unit 28 is used to measure the resistance of the switch 20 in a measurement period. The resistance is determined on the basis of a voltage drop. The current pulse causes this resistance to change. In particular, the current pulse results in an increase in resistance. This increase is due to heat. The measurement of the resistance can take place in a measurement period during the current pulse. It is also possible to measure the resistance after the current pulse. This measurement can therefore take place during the heating phase or during the cooling phase.

A resistance/temperature curve for the switch 20 is created in the evaluation unit 20 based on the measured resistance. A predefined prediction model is used for this. In particular, machine learning can be used for this. By way of example, a pretrained artificial neural network can be used as the predefined prediction model, which receives the measured resistance value for the current pulse as input, and outputs a resistance/temperature curve. An artificial neural network is used for this, which has been previously trained with a calibration, or a previously defined training phase, using actual measurement values.

A calibration command can be received in the (optional) input interface 32. This calibration command can be sent to a vehicle control unit for example. It is also possible to receive it through a wireless connection. The calibration command can trigger a re-execution of the approach used in the present disclosure. An internal or external signal can thus cause the current pulse to be sent to the switch 20 again, after which the resistance is measured and a resistance/temperature curve is obtained. The input interface 32, along with the calibration command, thus allows for recalibration while in use. A new resistance/temperature curve can be obtained while a power semiconductor 18 is in use in order to map aging effects and to obtain a correct and relevant temperature measurement, even after it has been in use for a long time.

A training apparatus 34 for creating a prediction model is shown schematically in FIG. 3. The training apparatus 34 contains an input interface 36 and a modeling unit 38. The input interface 36 and the modeling unit 38 can also be formed by hardware and/or software. The training apparatus 34 can be part of the device 22, or it can be integrated therein. The training apparatus 34 can also be a separate unit. Numerous (in particular, actual measured) resistance/temperature curves from different switches 20 are received in the input interface 36. In addition, various measurement values for the resistance, or forward resistance, of the switch 20 in question when it is subjected to a current pulse can be received therein. This data is used in the modeling unit 38 to obtain the prediction model. An artificial neural network can be trained therewith. By way of example, resistance/temperature curves as well as corresponding measurement values for the development of the resistance when subjected to a current pulse are thus determined for various switches 20 with corresponding current pulses. This training data is then used to generate a type of general plotting rule.

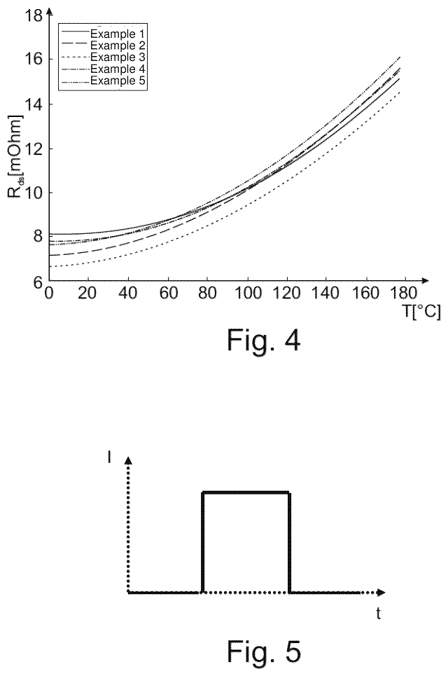

Five resistance/temperature curves for different switches 20 are shown schematically (qualitatively) in FIG. 4. It can be derived therefrom that different components can display a clear scattering, requiring a characterization of the component (e.g. in a calibration) to obtain a high level of precision in measuring the temperature.

It is therefore proposed according to the present disclosure that the switch 20 be operated with a current pulse for a specific amount of time directly after the production of a power semiconductor module 18. When the power semiconductors 24 is subjected to a current pulse it heats up, thus changing the resistance. This can be measured. A value is thus obtained for the change in resistance over time (resistance/time curve) which indirectly contains the characteristic of the resistance/temperature curve.

An exemplary current pulse is shown schematically in this context in FIG. 5. Time is plotted on the x-axis, and amperage is plotted on the y-axis. The current pulse illustrated therein has a constant amperage.

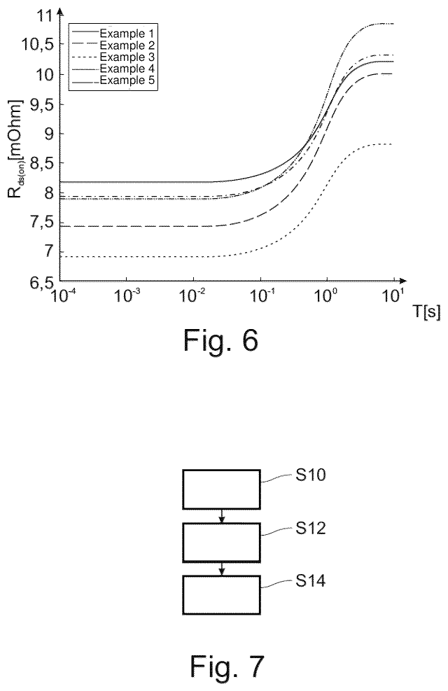

Examples of resistance/temperature curves are shown in FIG. 6. In this graph, time is plotted on a semilogarithmic x-axis, and resistance is plotted on a dimensionless y-axis. Different components have different resistance/temperature curves. By way of example, a current pulse of 180 Å can be used for 10 seconds. It has also proven to be advantageous to use a current pulse of 200 Å for 1 second. This resistance/time curve can correspond, for example, to the resistance measurement from the measurement unit.

It is possible to obtain measurement values for the heating curve (when the current pulse is applied) and/or for the cooling curve (using an additional, small sensor current). The values for the heating curve and cooling curve are characteristic of the thermal path and can be used to detect problems in the thermal path or to increase precision.

Based on different measurements, a resistance/temperature curve can be determined with a high level of precision, e.g. using deep learning. Various data sets are needed for this deep learning training process. These can be acquired using temperature sensors. With enough data, a resistance/temperature curve can be extrapolated using a predefined prediction model, even if the switch does not reach the desired temperature when the current pulse is applied. It is clear that training data are needed to plot the extrapolated value range. Unlike with prior approaches, the approach used in the present disclosure can reduce costs, because there is no need for calibration at high temperatures. The internal voltage measurement of a power semiconductor module can be used, such that there is no need for additional hardware.

The approach used in the present disclosure can also be used to quickly measure temperature-dependent values during production. This approach can also be used to quickly measure and check a thermal path in the production. It is possible to recalibrate during operation. By way of example, pulse patterns can be retrieved when the vehicle is stationary, with which recalibration of the temperature measurement in the power semiconductor can take place. This may be useful if there is a drifting of the electrical or thermal parameters. It is also fundamentally possible to use the cooling curve when stationary for early detection of aging in the thermal path. It is therefore possible to monitor the resistance, or change in resistance when the switch cools at regular intervals for an early detection of changes. Recalibration fundamentally improves the precision of the temperature measurement.

It is also possible to check capacitances (in intermediate circuit capacitors, chip capacitors) or inductances (in motor coils) with the approach used in the present disclosure using current or voltage pulses, or triangular signals.

A method for determining a temperature dependency of a forward resistance in a switch 20 is schematically shown in FIG. 7. The method comprises a first step S10 for applying a current pulse to the switch 20. In the second step S12, the resistance of the switch 20 is measured in a measurement period. A resistance/temperature curve for the switch is determined in the third step S14. The method can be implemented with software, for example, which is executed on a processor for a power semiconductor module 18. The method could also be executed in some other device or unit.

The present disclosure has been comprehensively described and explained in reference to the drawings. The descriptions and explanations are understood to be examples and not limiting. The present disclosure is not limited to the disclosed embodiments. Other embodiments or variations can be derived by the person skilled in the art when using the present disclosure, or through a precise analysis of the drawings, the disclosure and the following claims.

In the claims, the words, “comprising” and “with” do not exclude the possibility of there being other elements or steps. The indefinite articles “a” or “an” do not exclude the possibility of a plurality. A single element or unit can have the function of numerous units specified in the claims. An element, unit, interface, device, or system can be implemented, partially or entirely, with hardware and/or software. Simply specifying certain measures in different dependent claims is not to be understood to mean that a combination of these measures is not also advantageous. Reference symbols in the claims are not to be regarded as limiting.

### REFERENCE SYMBOLS

10 vehicle
12 traction inverter
14 battery
16 electric machine
18 power semiconductor module
20 switch
22 device
24 power semiconductor
26 pulse unit
28 measurement unit
30 evaluation unit
32 input interface
34 training apparatus
36 input interface
38 modeling unit

1. A device for determining temperature dependency of a forward resistance in a switch in a power semiconductor module comprising:
a pulse unit configured to send a current pulse to the switch;
a measurement unit configured to measure the resistance in the switch during a measurement period while and/or after the current pulse has been sent to the switch; and
an evaluation unit configured to determine a resistance/temperature curve for the switch based on the measured resistance and a predefined prediction model.

2. The device according to claim 1,
wherein the pulse unit is configured to send the current pulse to the switch lasting between 0.5 and 20 seconds, with an amperage between 50 Å0 and 500 Å.

3. The device according to claim 1,
wherein the measurement unit is configured to measure the resistance based on a voltage measurement during the application of the current pulse to the switch, and/or based on a voltage measurement of a measurement current after applying the current pulse to the switch.

4. The device according to claim 1,
wherein the evaluation unit is configured to determine the resistance/temperature curve based on machine learning with a pretrained model and/or with a pretrained artificial neural network.

5. The device according to claim 1,
wherein the pulse unit is configured to apply the current pulse to the switch that has numerous power semiconductors connected in parallel.

6. The device according to claim 1, comprising:
an input interface configured to receive a calibration command,
wherein the pulse unit is configured to send the current pulse to the switch after receiving the calibration command,
wherein the measurement unit is configured to measure the resistance after receiving the calibration command, and
wherein the evaluation unit is configured to determine the resistance/temperature curve after receiving the calibration command.

7. The device according to claim 6,
wherein the input interface is configured to receive the calibration command from a vehicle control unit, through a wireless connection, and/or after a predefined operating condition arises.

8. A traction inverter for a vehicle comprising:
a switch in a power semiconductor module; and
the device according to claim 1,
wherein the measurement unit is configured to measure the resistance of the switch, and the evaluation unit is configured to determine the temperature of the switch based on the resistance/temperature curve.

9. A training device for obtaining a prediction model, comprising:
an input interface configured to receive numerous resistance/temperature curves for different switches; and
a modeling unit configured to obtain the prediction module based on the resistance/temperature curves, wherein the modeling unit is configured for training an artificial neural network.

10. A method of determining temperature dependency of a forward resistance in a switch, comprising:
sending a current pulse to the switch;
measuring the resistance of the switch during a measurement period while and/or after the current pulse is applied to the switch; and
determining a resistance/temperature curve for the switch based on the measured resistance and a predefined prediction model.

11. The method according to claim 10, comprising:
sending the current pulse to the switch lasting between 0.5 and 20 seconds, with an amperage between 50 Å and 500 Å.

12. The method according to claim 10, comprising:
measuring the resistance based on a voltage measurement during the application of the current pulse to the switch, and/or based on a voltage measurement of a measurement current after applying the current pulse to the switch.

13. The method according to claim 10, comprising:
determining the resistance/temperature curve based on machine learning with a pretrained model and/or with a pretrained artificial neural network.

14. The method according to claim 10, comprising:
applying the current pulse to the switch that has numerous power semiconductors connected in parallel.

15. The method according to claim 10, comprising:
receiving a calibration command;
sending the current pulse to the switch after receiving the calibration command;
measuring the resistance after receiving the calibration command; and
determining the resistance/temperature curve after receiving the calibration command.

16. The method according to claim 15, comprising:
receiving the calibration command from a vehicle control unit, through a wireless connection, and/or after a predefined operating condition arises.

17. A non-transitory computer readable medium having stored thereon a computer program containing commands that, when executed by a processing device, cause the processing device to perform the method according to claim 10.
